(19) United States
(12) Patent Application Publication
(10) Pub. No.: US 2008/0316012 A1
(43) Pub. Date: Dec. 25, 2008

(54) Goods-Carrying Vehicle with Lighting Units that can be Controlled by Means of Plc (Power Line Communication)

(75) Inventors: Sascha Paasche, Tokyo (JP); Andreas Schwarzhaupt, Landau (DE); Gernot Spiegelberg, Bad Abbach (DE); Armin Sulzmann, Heidelberg (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/667,931

(22) PCT Filed: Nov. 8, 2005
(86) PCT No.: PCT/EP05/11926

§ 371 Date: Feb. 29, 2008

(30) Foreign Application Priority Data
Nov. 20, 2004 (DE) 10 2004 056 123.0

(51) Int. Cl. B60Q 11/00

(52) U.S. Cl. 340/458

(57) ABSTRACT

The invention relates to a utility vehicle, in particular a truck with or without a trailer, having an on-board electric power system (1) for supplying power to electrical loads of the vehicle, having a plurality of lighting units (2) which are connected to the on-board electric power system (1) and which emit light when they are activated, and having a plurality of switches (3) for activating the lighting units (2). The switches (3) advantageously activate at least some of the lighting units (2) by means of PLC via the on-board electric power system (1).

### BACKGROUND AND SUMMARY OF THE INVENTION

This invention relates to a utility vehicle, in particular a truck with or without a trailer.

A conventional utility vehicle usually comprises an on-board electric power system for supplying power to electrical loads of the vehicle. Furthermore, such a utility vehicle is usually equipped with a plurality of lighting units which are connected to the on-board electric power system and which emit light when they are activated. Such lighting units comprise, for example, left-hand front lights, right-hand front lights, left-hand rear lights, right-hand rear lights, central rear lights and the like. In order to activate these lighting units, the vehicle is also equipped with a corresponding number of switches.

U.S. Pat. No. 6,545,593 discloses a utility vehicle in the form of a truck tractor with an associated semitrailer. In order to communicate the state of an automatic brake system of the semitrailer to the truck tractor, the utility vehicle operates with PLC which is implemented via the power supply of the automatic brake system. Here, PLC stands for “Power Line Communication”, which amounts to transmitting data over power supply lines. In this known vehicle, status signals of the automatic brake system of the semitrailer can thus be transmitted over the power supply lines of a respective controller of the truck tractor, without additional signal lines having to be laid for this purpose.

German document DE 102 48 456 A1 discloses allowing individual control devices of a vehicle to communicate with one another redundantly via a communication line which is specifically provided for that purpose and via a power supply line by means of PLC.

U.S. Patent application publication 2003/0197426 A1 discloses controlling individual power load groups in a building, for example lighting systems of the building, remotely by means of PLC via the power supply lines of the loads.

U.S. Pat. No. 6,118,371 discloses a method for handling faults in lighting units with two radiant filaments. If, for example, the dipped headlights fail, the spiral-wound filament of the full beam headlights are actuated by a pulse-width-modulator power supply with a lower level of energy so that the full beam headlights can temporarily replace the dipped headlights in this case. The on-board electric power system and the transmission of data are carried out here by means of a conventional electronic architecture.

Sauer, Bruce: “New Power for Trailers”; U.S. periodical “Bulk Transporter”, 10.1.2000, discloses using PLC in a utility vehicle without details about the electronic architecture.

German document DE 102 16 564 A1 describes a utility vehicle with power line communication for use in an ABS system and particularly for use in the trailer there. An indication of the possibility of actuating the lighting system is given in this document.

Taking the subject matter of German document DE 102 16 564 A1 as a starting point, the present invention is concerned with the problem of specifying, for a vehicle of the type mentioned at the beginning, an improved embodiment which can be implemented economically, preferably provides enhanced functionality, and can increase the safety of the vehicle.

According to the invention this problem is solved by the subject matter claimed. Advantageous embodiments form the subject matter of dependent claims.

The invention is based on the general idea of implementing the activation of lighting units of the vehicle using power line communication, or by PLC. For this purpose, the respective lighting units must comprise control devices or the like which permit individual lighting elements of the respective lighting unit to be activated as a function of control signals. However, as a result of the design according to the invention, no separate control lines are necessary since the control signals are transmitted via the on-board electrical power system to which the respective lighting units are connected for their power supply. The expenditure on implementing a lighting system in a motor vehicle which has lighting units comprising control devices is thus simplified. In particular it is thus possible to mount modern lighting units which are equipped with a control device, instead of conventional lighting units, without the on-board electric power system having to be modified for this purpose. Furthermore, this considerably simplifies the retrofitting with lighting units which are equipped with such control devices.

Further important features and advantages of the invention will become apparent from the claims, from the drawings, and from the associated description of the figures with reference to the drawings.

Of course, the features which are mentioned above and which are still to be explained below can be used not only in the respectively specified combination but also in other combinations or alone without departing from the scope of the present invention.

Preferred exemplary embodiments of the invention are illustrated in the drawings and will be explained in more detail in the following description, in which identical reference symbols relate to identical or functionally identical or similar components.

### BRIEF DESCRIPTION OF THE DRAWINGS

FIG. 1 shows a circuit diagram-like basic illustration of lighting units which are connected to an on-board electric power system, and

FIG. 2 is an illustration as in FIG. 1 but in another embodiment.

### DETAILED DESCRIPTION OF THE INVENTION

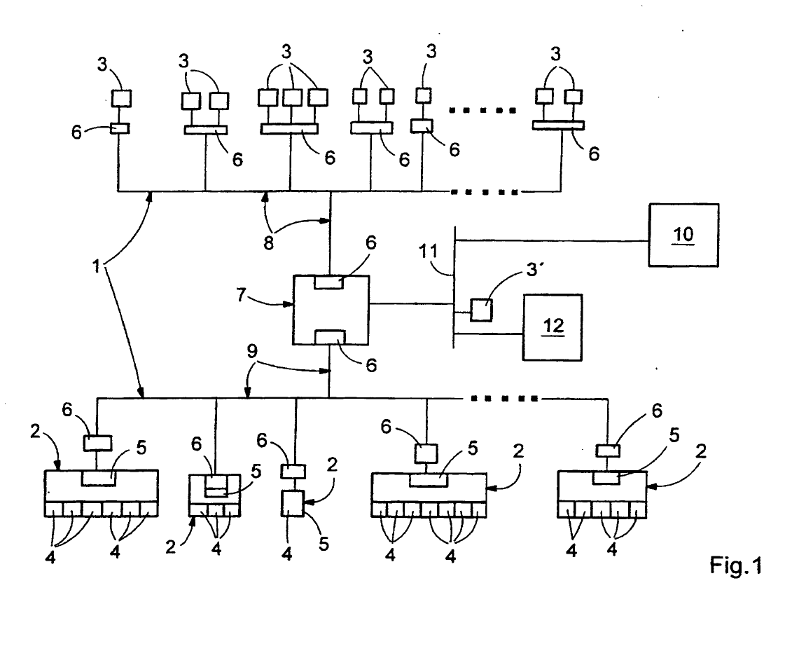

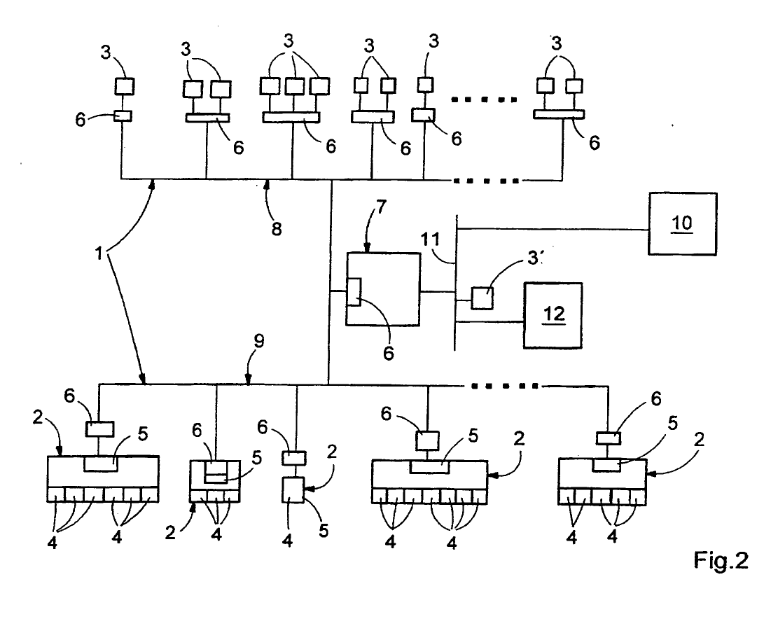

According to FIGS. 1 and 2, a utility vehicle which is not illustrated here is equipped with an on-board electric power system 1 (illustrated only partially here) and with a plurality of lighting units 2 which are connected to the on-board electric power system 1. Furthermore, a plurality of switches 3 are provided for activating the lighting units 2. The lighting units 2 can be arranged here on a truck and/or on a trailer of such a truck. The lighting units 2 may have a single lighting element 4 or a plurality of lighting elements 4. For example, a lighting unit 2 comprises all the lighting elements 4 which are arranged on the left at the rear of the vehicle, for example brake light, flasher indicator light, tail light, reversing light and tail fog light.

The on-board electric power system 1 serves in the customary way to supply power to electrical loads of the vehicle. These electrical loads include also the lighting units 2 or their lighting elements 4.

The lighting units 2 are each equipped with a lighting control device 5 which can evaluate incoming switching instruction signals and activate, as a function thereof, one or more lighting elements 4 of the respective lighting unit 2 for emitting light. In a lighting unit 2 which has just a single lighting element 4, the control device 5 can be integrated into the lighting element 4.

The lighting units 2 are also each equipped with a PLC transceiver 6. Such transceivers 6 can read or pick up the signals which are modulated onto the on-board electric power system 1 and can transmit them to the respective lighting control device 5 in a suitable way. In particular, the PLC transceivers 6 can, as a function of switching instruction signals which are transmitted via the on-board electric power system 1, activate the associated lighting unit 2 by supplying the associated lighting control device 5 with the switching instruction signals. Furthermore, the PLC transceivers 6 can feed status signals into the on-board electric power system 1 which the respective lighting units 2 can generate as a function of their state. Such status signals can be generated by the lighting units 2 automatically or on request in this case. For example, such a status signal comprises the information as to which lighting elements 4 of the respective lighting unit 2 are correctly operating, which are incorrectly operating or which are not operating.

The PLC transceivers 6 are connected upstream of the respective lighting unit 2 here with respect to the on-board electric power system 1. It is basically possible here to integrate such a PLC transceiver 6 into the respective lighting unit 2.

The switches 3 are likewise equipped individually or severally with PLC transceivers 6 which can basically be structurally identical to those of the lighting units 2. The PLC transceivers 6 which are assigned to the switches 3 are constructed in such a way that if an assigned switch 3 is activated they feed into the on-board electric power system 1 a switch signal which is assigned to the respectively activated switch 3.

In the vehicle according to the invention, the lighting units 2 are activated by the switches 3 by means of PLC via the on-board electric power system 1. Accordingly, no separate control lines are necessary. It is clear here that the vehicle can basically also be equipped with other, conventional lighting units 2 which are either activated by means of signal lines or by switching associated power supply lines on and off.

The PLC transceivers 6 which are assigned to the switches 3 are expediently configured in such a way that they generate switch signals which each have a source identifier assigned to the respective switch 3. In this way it is possible to assign each switch signal to a specific switch 3. Furthermore, the switching instruction signals can each also have at least one destination identifier which is assigned to at least one lighting unit 2. In this way, the switching instruction signals can be evaluated by the PLC transceivers 6 assigned to the lighting units 2 or by the lighting control devices 5 in order to bring about activation of the respectively desired lighting element 4.

In a particularly simple case, the switch signals can simultaneously form the switching instruction signals. This means that when the respective switch 3 is activated by means of the associated PLC transceiver 6, it generates a switch signal which is evaluated by the PLC transceivers 6, assigned to the lighting units 2, as a switching instruction signal and is used, by means of the respective lighting control device 5, to activate the respective lighting element 4.

An embodiment in which, as in FIGS. 1 and 2, a central unit 7 is provided is preferred. This central unit 7 is likewise connected to the on-board electric power system 1 and is configured in such a way that it generates switching instruction signals as a function of switch signals. In this context, the central unit 7 receives the switch signals transmitted via the on-board electric power system 1, evaluates them, generates the switching instruction signals and feeds them into the on-board electric power system 1. By means of the central unit 7 it is possible, for example, to configure the assignments of the individual switches 3 to the individual lighting elements 4.

In the embodiment shown in FIG. 1, the switches 3 are connected to a switch branch 8 of the on-board electric power system 1, while the lighting units 2 are connected to a lighting branch 9 of the on-board electric power system 1. The switch branch 8 is isolated here from the lighting branch 9, i.e. the on-board electric power system 1 does not lead directly from the switches 3 to the lighting units 2. In this embodiment, the central unit 7 is connected, on the one hand, to the switch branch 8 via a first PLC transceiver 6, and to the lighting branch 9 via a second PLC transceiver 6. This means that the central unit 7 receives the switching instructions from the switch branch 8 and feeds the switching instruction signals generated as a function thereof into the lighting branch 9.

In contrast to this, in the embodiment 2 according to FIG. 2, the on-board electric power system 1 is configured in such a way that the switch branch 8 is coupled to the lighting branch 9 so that the on-board electric power system 1 leads from the switches 3 to the lighting units 2. In this embodiment, the central unit 7 is connected via a single PLC transceiver 6 to the on-board electric power system 1. Via this PLC transceiver 6, the central unit 7 both extracts the switch signals from the on-board electric power system 1 and feeds into the on-board electric power system 1 the switching instruction signals which are generated as a function of the switch signals. By virtue of the different structure of the signals, in particular by virtue of the source identifier or by virtue of the destination identifier the respective PLC transceivers 6 or the lighting control devices 5 coupled to them can detect and implement the respective relevant signals.

An embodiment in which the central unit 7 takes into account the status signals generated by the lighting units 2 in the generation of the switching instruction signals is particularly advantageous. In this way it is possible, if a lighting element 4 fails, to make alternative use of another lighting element 4 which can carry out the same function. For example, if a flasher indicator light fails, a flasher light can alternatively also be generated by virtue of the fact that a brake light is actuated with a flashing rhythm. In this way, the safety of the vehicle is increased. This is realized by virtue of the fact that if a lighting element 4, for example the indicator flasher light, fails in a lighting unit 2, for example at the rear on the left, the central unit 7 modifies a switching instruction signal which is necessary to activate this lighting element 4 in such a way that instead of this lighting element 4 another lighting element 4, for example the brake light, of the same lighting unit 2 or, if appropriate, of another lighting unit 2 is activated.

In addition, the central unit 7 can ensure that the malfunction of a lighting unit 2 or of a lighting element 4 is indicated to the driver of a vehicle in a suitable way. For example, the central unit 7 is, for this purpose, coupled to a display device 10, which can be arranged in a cockpit of the vehicle. The central unit 7 then displays the respective malfunction on this display device 10. In the present case, the coupling between the central unit 7 and the display device 10 is carried out by means of a bus 11, for example via a CAN bus 11 which is laid in the vehicle in order to connect control devices.

The central unit 7 can find out the current state of the individual lighting units 2 through corresponding interrogations through which the individual lighting units 2 or their control devices 5 are actuated to output suitable status signals. These status signals expediently each comprise a source identifier which is assigned to the respective lighting unit 2 so that the control device 7 can also assign the status signals or the state information contained in them to the correct lighting device 2.

In the preferred embodiments shown here, the central unit 7 is also connected to a vehicle controller 12, which can be done, for example, again via the bus 11. In this way, the central unit 7 can receive state information or access state information which describes the current state of the vehicle. Vehicle states are, for example, acceleration, deceleration, forward travel, rearward travel, and stationary state. The central unit 7 can then take into account the current state information in the generation of the switching instruction signals. For example, the brake lights can be actuated with differing light intensities as a function of a braking deceleration. Furthermore, it is basically possible for the central unit 7 to generate switching instruction signals independently of switch signals and to feed them into the on-board electric power system 1 if the state information meets predetermined conditions for this. For example, the vehicle can be comparatively strongly decelerated by engine braking. For safety reasons, in this context the central unit 7 simultaneously generates switching instruction signals which generate a brake light without a brake switch which is assigned to a brake pedal having to be activated for this purpose.

Basically it is likewise possible that at least one other switch 3′ does not communicate with the central unit 7 by means of PLC but rather in some other way. For example, such a switch 3′ can be connected to the central unit 7 via the bus 11. For example, this switch 3′ is a brake light switch which is activated when the brake pedal is activated.

1-8. (canceled)

9. A utility vehicle comprising:
an on-board electric power system for supplying power to electrical loads of the vehicle,
a plurality of lighting units which are connected to the on-board electric power system and which emit light when activated,
a plurality of switches for activating the lighting units by way of PLC via the on-board electric power system,
a central unit connected to the on-board electric power system and adapted to generate switching instruction signals as a function of switch signals transmitted via the on-board electric power system,
wherein said central unit feeds said switching instruction signals into the on-board electric power system,
wherein when a lighting element in one of the lighting units fails, the central unit modifies a switching instruction signal which is necessary to activate the lighting element in such a way that, instead of the lighting element, another lighting element of said one of the lighting units or of another of said lighting units is activated,
wherein the switches are connected to a switch branch of the on-board electric power system,
wherein the lighting units are connected to a lighting branch, decoupled from the switch branch, of the on-board electric power system,
wherein the lighting units are equipped with first PLC transceivers and the switches are individually or severally equipped with second PLC transceivers, and
wherein the central unit is connected to both the switch branch via a third PLC transceiver and to the lighting branch via a fourth PLC transceiver.

10. The utility vehicle as claimed in claim 9, wherein each of the switch signals has a source identifier assigned to a respective switch, wherein each of the switching instruction signals has at least one destination identifier assigned to a lighting unit, or wherein each of the switch signals has the source identifier and each of the switching instruction signals has the at least one destination identifier.

11. The utility vehicle as claimed in claim 9, wherein the lighting units generate status signals automatically and on request as a function of their states and feed them into the on-board electric power system.

12. The utility vehicle as claimed in claim 11, wherein each of the status signals has a source identifier which is assigned to a respective lighting unit.

13. The utility vehicle as claimed in claim 11, wherein the central unit takes into account the status signals in generation of the switching instruction signals.

14. The utility vehicle as claimed in claim 11, wherein the central unit indicates malfunctions of the lighting units in a cockpit of the vehicle by way of a suitable display device.

15. The utility vehicle as claimed in claim 9, wherein the central unit is connected to a vehicle controller in order to transmit state information about a current state of the vehicle, and wherein the central unit takes into account this additional information in generation of the switching instruction signals.

16. The utility vehicle as claimed in claim 9, wherein the utility vehicle is a truck, and the lighting units are arranged on the truck.

17. The utility vehicle as claimed in claim 9, wherein the utility vehicle is a truck with a trailer, and wherein the lighting units are arranged on at least one of the truck and the trailer.

18. The utility vehicle as claimed in claim 10, wherein the lighting units generate status signals automatically and on request as a function of their states and feed them into the on-board electric power system.

19. The utility vehicle as claimed in claim 17, wherein each of the status signals has a source identifier which is assigned to a respective lighting unit.

20. The utility vehicle as claimed in claim 17, wherein the central unit takes into account the status signals in generation of the switching instruction signals.

21. The utility vehicle as claimed in claim 17, wherein the central unit indicates malfunctions of the lighting units in a cockpit of the vehicle by way of a suitable display device.

22. The utility vehicle as claimed in claim 10, wherein the utility vehicle is a truck, and the lighting units are arranged on the truck.

23. The utility vehicle as claimed in claim 11, wherein the utility vehicle is a truck, and the lighting units are arranged on the truck.

24. The utility vehicle as claimed in claim 12, wherein the utility vehicle is a truck, and the lighting units are arranged on the truck.

25. The utility vehicle as claimed in claim 13, wherein the utility vehicle is a truck, and the lighting units are arranged on the truck.

26. The utility vehicle as claimed in claim 14, wherein the utility vehicle is a truck, and the lighting units are arranged on the truck.

27. The utility vehicle as claimed in claim 15, wherein the utility vehicle is a truck, and the lighting units are arranged on the truck.

28. The utility vehicle as claimed in claim 17, wherein the lighting units are arranged on the truck.
